(19) United States
(12) Patent Application Publication
(10) Pub. No.: US 2020/0018655 A1
(43) Pub. Date: Jan. 16, 2020

(54) FORCE SENSING CUSHION

(71) Applicants: Ming-Shian Wu, New Taipei City (TW); Sung-Yang Wu, Hsinchu City (TW)

(72) Inventors: Ming-Shian Wu, New Taipei City (TW); Sung-Yang Wu, Hsinchu City (TW)

(21) Appl. No.: 16/033,157

(22) Filed: Jul. 11, 2018

(51) Int. Cl. G01L 1/14; G01L 1/18

(52) U.S. Cl. CPC G01L 1/146; G01L 1/18

(57) ABSTRACT

A force sensing cushion includes a force senor matrix and a calculating unit. The force sensor matrix is configured to detect stress distribution applied by a user sitting on the force sensing cushion. The calculating unit is connected with the force sensor matrix, and the calculating unit is configured to calculate a stress center of the stress distribution for tracking the posture of the user sitting on the force sensing cushion.

### BACKGROUND OF THE INVENTION

### 1. Field of the Invention

The present invention relates to a force sensing cushion, and more particularly, to a force sensing cushion including a force sensor matrix.

### 2. Description of the Prior Art

As virtual reality (VR) and the related applications are getting more and more popular, the virtual reality equipment is developed rapidly. Generally, a head-mounted display device and a handheld controller are the typical virtual reality equipment. However, some postures of the user are hard be detected by the handheld controller only, and the related applications are limited accordingly.

### SUMMARY OF THE INVENTION

A force sensing cushion is provided in the present invention. Stress distribution applied by a user sitting on the force sensing cushion is detected by a force sensor matrix in the force sensing cushion. A calculating unit connected with the force sensor matrix is used to calculate a stress center of the stress distribution for tracking the posture of the user sitting on the force sensing cushion.

According to an embodiment of the present invention, a force sensing cushion is provided. The force sensing cushion includes a force senor matrix and a calculating unit. The force sensor matrix is configured to detect stress distribution applied by a user sitting on the force sensing cushion. The calculating unit is connected with the force sensor matrix, and the calculating unit is configured to calculate a stress center of the stress distribution.

In one embodiment of the present invention, the calculating unit may be further configured to calculate a variation of the stress center. The variation of the stress center may include a variation in direction and/or a movement rate of the stress center.

In one embodiment of the present invention, the force sensing cushion may further include a flexible housing, and the force sensor matrix may be disposed inside the flexible housing.

In one embodiment of the present invention, the force sensor matrix may include force sensor units arranged in a matrix.

In one embodiment of the present invention, each of the force sensor units may include a piezoresistive force sensor unit or a capacitance force sensor unit.

In one embodiment of the present invention, each of the force sensor units maybe configured to detect stress from the user sitting on the force sensing cushion in a vertical direction.

In one embodiment of the present invention, the force sensing cushion may further include a transmitter module connected with the calculating unit, and the transmitter module may be configured to transmit signals from the calculating unit.

In one embodiment of the present invention, the transmitter module may include a wireless transmitter module and/or a wired transmitter module.

In one embodiment of the present invention, the transmitter module may transmit the signals from the calculating unit to a virtual reality (VR) device.

In one embodiment of the present invention, the force sensing cushion may be a controller for the virtual reality device.

In one embodiment of the present invention, the force sensor matrix may be further configured to determine whether there is a user sitting on the force sensing cushion or not.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating a force sensing cushion according to an embodiment of the present invention.

FIG. 2 is a cross-sectional view of the force sensing cushion according to an embodiment of the present invention.

FIG. 3A is a schematic drawing illustrating stress distribution on the force sensing cushion when a user sitting on the force sensing cushion leans forward.

FIG. 3B is a schematic drawing illustrating stress distribution on the force sensing cushion when a user sitting on the force sensing cushion leans back.

FIG. 3C is a schematic drawing illustrating stress distribution on the force sensing cushion when a user sitting on the force sensing cushion leans to the left side of the user.

FIG. 3D is a schematic drawing illustrating stress distribution on the force sensing cushion when a user sitting on the force sensing cushion leans to the right side of the user.

FIG. 4 is a schematic drawing illustrating a variation of a stress center detected and calculated by the force sensing cushion according to an embodiment of the present invention.

FIG. 5 is a block diagram of the force sensing cushion according to an embodiment of the present invention.

### DETAILED DESCRIPTION

In the following detailed description of the invention, reference is made to the accompanying drawings, which form a part hereof, and in which is shown, by way of illustration, specific embodiments in which the invention may be practiced. These embodiments are described in sufficient detail to enable those skilled in the art to practice the invention. Other embodiments maybe utilized and structural changes may be made without departing from the scope of the present invention.

The following detailed description is, therefore, not to be taken in a limiting sense, and the scope of the present invention is defined only by the appended claims, along with the full scope of equivalents to which such claims are entitled. One or more implementations of the present invention will now be described with reference to the attached drawings, wherein like reference numerals are used to refer to like elements throughout, and wherein the illustrated structures are not necessarily drawn to scale.

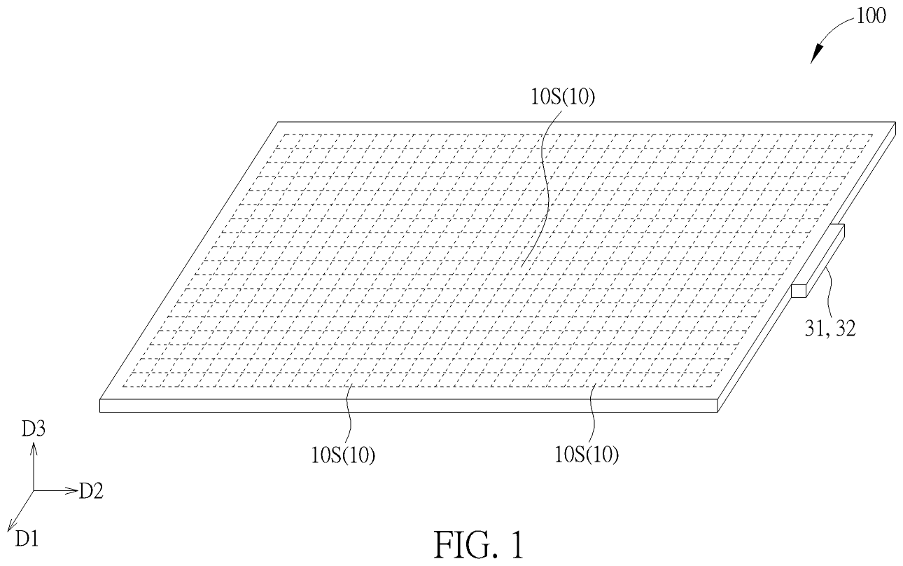

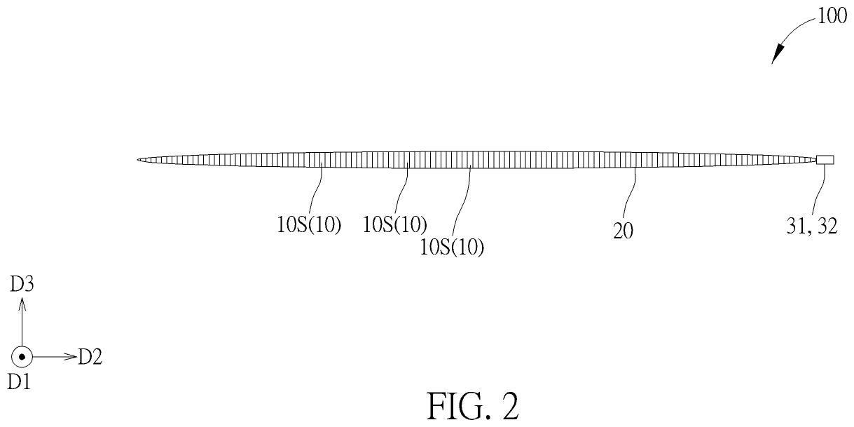

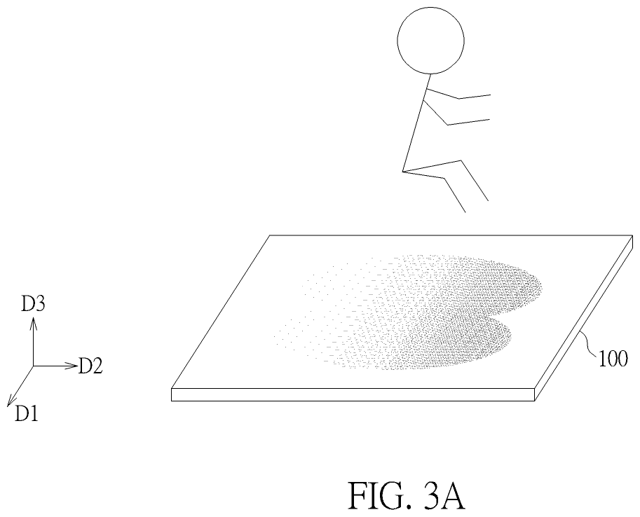

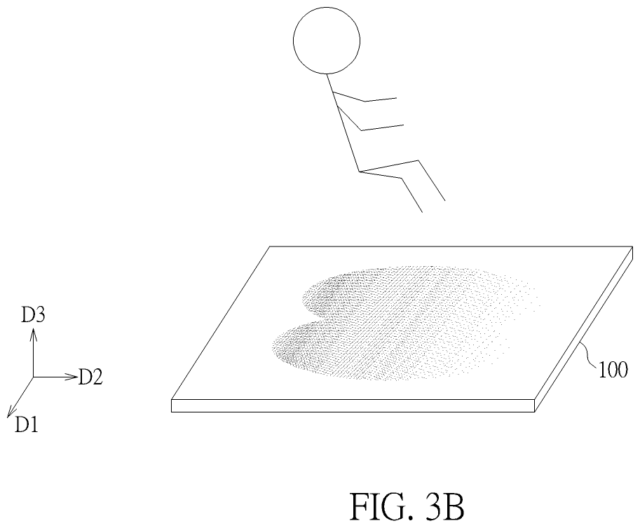

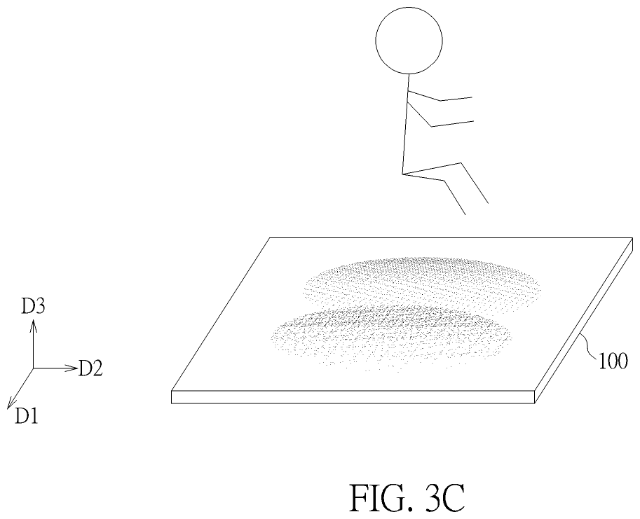

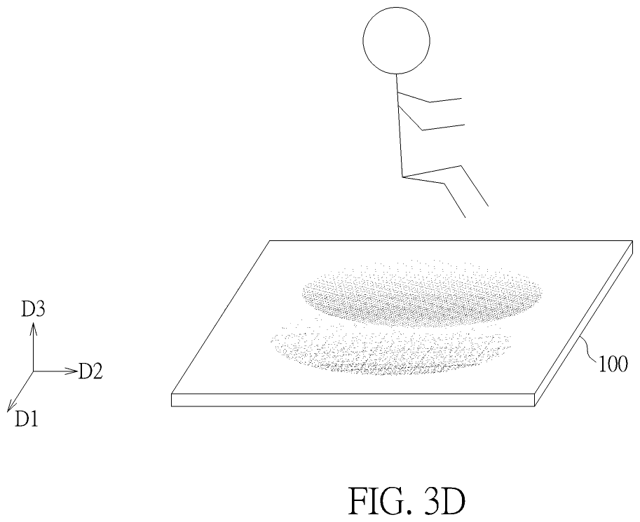

Please refer to FIG. 1, FIG. 2, FIG. 3A, FIG. 3B, FIG. 3C, and FIG. 3D. FIG. 1 is a schematic drawing illustrating a force sensing cushion according to an embodiment of the present invention. FIG. 2 is a cross-sectional view of the force sensing cushion in this embodiment. FIG. 3A is a schematic drawing illustrating stress distribution on the force sensing cushion when a user sitting on the force sensing cushion leans forward. FIG. 3B is a schematic drawing illustrating stress distribution on the force sensing cushion when a user sitting on the force sensing cushion leans back. FIG. 3C is a schematic drawing illustrating stress distribution on the force sensing cushion when a user sitting on the force sensing cushion leans to the left side of the user. FIG. 3D is a schematic drawing illustrating stress distribution on the force sensing cushion when a user sitting on the force sensing cushion leans to the right side of the user. As shown in FIG. 1 and FIG. 2, a force sensing cushion 100 is provided in this embodiment. The force sensing cushion 100 includes a force senor matrix 10 and a calculating unit 31. The force sensor matrix 10 is configured to detect stress distribution applied by a user sitting on the force sensing cushion 100. The calculating unit 31 is connected with the force sensor matrix 10, and the calculating unit 31 is configured to calculate a stress center of the stress distribution. The calculating unit 31 may include a microprocessor or other suitable calculating devices. In some embodiments, the force sensor matrix 10 may include force sensor units 10S arranged in a matrix. A part of the force sensor units 10S may be disposed along a first direction D1, and a part of the force sensor units 10S may be disposed along a second direction D2 perpendicular to the first direction D1, but not limited thereto. The precision of accuracy of the stress detection performed by the force sensor matrix 10 may be enhanced by increasing the amount and the density of the force sensor units 10S in the force sensor matrix 10. In some embodiments, each of the force sensor units 10S may include a piezoresistive force sensor unit, a capacitance force sensor unit, or other suitable types of force sensors. Each of the force sensor units 10S may be configured to detect stress from the user sitting on the force sensing cushion 100 in a vertical direction D3. The vertical direction D3 may be perpendicular to a plane formed by a vector extending in the first direction D1 and a vector extending in the second direction D2, but not limited thereto. The stress detected by the force sensor units 10S in the vertical direction D3 may form the stress distribution described above.

For instance, as shown in FIG. 1, FIG. 3A, FIG. 3B, FIG. 3C, and FIG. 3D, the stress distribution detected by the force sensor matrix 10 of the force sensing cushion 100 may change as the posture of the user sitting on the force sensing cushion 100 changes. Therefore, the posture of the user sitting on the force sensing cushion 100 may be tracked by detecting and analyzing the stress distribution on the force sensing cushion 100. Additionally, the force sensor matrix 10 maybe further configured to determine whether there is a user sitting on the force sensing cushion 100 or not by detecting and analyzing the stress distribution on the force sensing cushion 100.

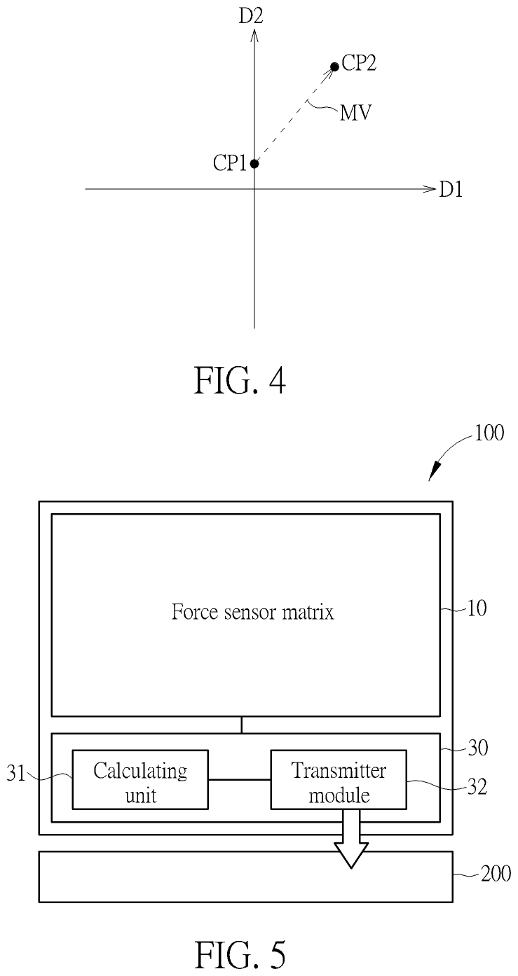

Please refer to FIG. 1, FIG. 3A, FIG. 3B, FIG. 3C, FIG. 3D, and FIG. 4. FIG. 4 is a schematic drawing illustrating a variation of a stress center detected and calculated by the force sensing cushion according to an embodiment of the present invention. As shown in FIG. 1 and FIG. 4, the calculating unit 31 is connected with the force sensor matrix 10, and the information about the stress distribution obtained by the force sensor matrix 10 may be outputted to the calculating unit 31 for calculating a stress center of the stress distribution. For instance, when the user sits on the force sensing cushion 100, a first stress center CP1 may be calculated by the calculating unit 31 with the stress distribution information detected by the force sensor matrix 10. When the posture of the user sitting on the force sensing cushion 100 change, the stress distribution information detected by the force sensor matrix 10 becomes different, and a second stress center CP2 different from the first stress center CP1 may be calculated by the calculating unit 31. In other words, the calculating unit 31 may be further configured to calculate a variation of the stress center. In some embodiments, the variation of the stress center may include a variation in direction (such as a movement vector MV shown in FIG. 4) and/or a movement rate of the stress center. For example, when the second direction D2 points towards the front side of the user sitting on the force sensing cushion 100, the first stress center CP1 may be calculated corresponding to the user sitting on the force sensing cushion 100 without leaning (that may be regarded as a neutral state), the second stress center CP2 may be calculated corresponding to the user leaning forward and leaning to the right side of the user, and the movement vector MV shown in FIG. 4 may be obtained accordingly. In some embodiments, the first direction D1 may be regarded as an X axis, the second direction D2 may be regarded as a Y axis, and movement vectors pointing toward the four quadrants may be obtained by the force sensing cushion 100. In other words, apart from detecting the user leaning forward, leaning back, leaning to the right side, and leaning to the left side, the force sensing cushion 100 may also be used to detect the posture of the user leaning to other directions because of the force sensor matrix 10 in the force sensing cushion 100.

It is worth noting that, in the present invention, the stress center may be calculated by the calculating unit 31 in accordance with the stress distribution information detected by the force sensor matrix 10 (such as the conditions shown in FIG. 3A, FIG. 3B, FIG. 3C, and FIG. 3D). A force sensing device with some force sensors disposed at certain positions only (such as four corners of the force sensing device) cannot generate the stress distribution information shown in FIG. 3A, FIG. 3B, FIG. 3C, and FIG. 3D, and the center of gravity of the user cannot be calculated precisely. The stress distribution may be obtained in more detail by using the force sensor matrix 10 in the present invention, and the stress center of the stress distribution and the center of gravity of the user sitting on the force sensing cushion 100 may be calculated more precisely. In addition, the shape of the stress distribution obtained by the force sensor matrix 10 may also be used to identify the subject placed on the force sensing cushion 100. For example, the shape of the stress distribution when a person sits on the force sensor matrix 10 will be different from the shape of the stress distribution when a pet (such as a dog or a cat) sits on the force sensor matrix 10.

As shown in FIG. 1 and FIG. 2, in some embodiments, the force sensing cushion 100 may further include a flexible housing 20, and the force sensor matrix 10 maybe disposed inside the flexible housing 20, but the present invention is not limited thereto. The material of the flexible housing 20 may include cloth, plastic, or other suitable flexible materials. In addition, a part of the calculating unit 31 may be disposed outside the flexible housing 20, and the user may sit on the flexible housing 20 and the force sensor matrix 10 only for avoiding sitting on the calculating unit 31, but not limited thereto. In some embodiments, the force sensor matrix 10 may be integrated in a flexible film without being disposed in a housing.

Please refer to FIG. 1 and FIG. 5. FIG. 5 is a block diagram of the force sensing cushion according to an embodiment of the present invention. As shown in FIG. 1 and FIG. 5, in some embodiments, the force sensing cushion 100 may further include a transmitter module 32 connected with the calculating unit 31, and the transmitter module 32 may be configured to transmit signals from the calculating unit 31, but not limited thereto. In some embodiments, the calculating unit 31 and the transmitter module 32 maybe disposed and/or integrated in an integrated circuit module 30, and the integrated circuit module 30 may be connected with the force sensor matrix 10, but not limited thereto. The transmitter module 32 may include a wireless transmitter module and/or a wired transmitter module. The wireless transmitter module described above may transmit signals through Wi-Fi, IR (infrared), Bluetooth, or other suitable wireless approaches. In some embodiments, the transmitter module 32 may transmit the signals from the calculating unit 31 to a virtual reality (VR) device 200, such as a head-mounted display device and/or a computer system, but not limited thereto. The signals transmitted from the calculating unit 31 to the virtual reality device 200 may include the information about the stress center of the stress distribution and/or the variation of the stress center described above. Therefore, the force sensing cushion 100 may be a controller for the virtual reality device 200, and the force sensing cushion 100 may provide the information about the posture and the movement of the user sitting on the force sensing cushion 100, but not limited thereto.

To summarize the above descriptions, in the force sensing cushion according to the present invention, the stress center may be calculated by the calculating unit in accordance with the stress distribution detected by the force sensor matrix. The stress distribution may be obtained in more detail by using the force sensor matrix of the present invention, and the stress center of the stress distribution, and the variation of the stress center may be calculated more precisely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A force sensing cushion, comprising:
a force sensor matrix configured to detect stress distribution applied by a user sitting on the force sensing cushion; and
a calculating unit connected with the force sensor matrix, wherein the calculating unit is configured to calculate a stress center of the stress distribution.

2. The force sensing cushion according to claim 1, wherein the calculating unit is further configured to calculate a variation of the stress center.

3. The force sensing cushion according to claim 2, wherein the variation of the stress comprises a variation in direction.

4. The force sensing cushion according to claim 2, wherein the variation of the stress comprises a movement rate of the stress center.

5. The force sensing cushion according to claim 1, further comprising:
a flexible housing, wherein the force sensor matrix is disposed inside the flexible housing.

6. The force sensing cushion according to claim 1, wherein the force sensor matrix comprises force sensor units arranged in a matrix.

7. The force sensing cushion according to claim 6, wherein each of the force sensor units comprises a piezoresistive force sensor unit or a capacitance force sensor unit.

8. The force sensing cushion according to claim 6, wherein each of the force sensor units is configured to detect stress from the user sitting on the force sensing cushion in a vertical direction.

9. The force sensing cushion according to claim 1, further comprising:
a transmitter module connected with the calculating unit, wherein the transmitter module is configured to transmit signals from the calculating unit.

10. The force sensing cushion according to claim 9, wherein the transmitter module comprises a wireless transmitter module and/or a wired transmitter module.

11. The force sensing cushion according to claim 9, wherein the transmitter module transmits the signals from the calculating unit to a virtual reality (VR) device.

12. The force sensing cushion according to claim 11, wherein the force sensing cushion is a controller for the virtual reality device.

13. The force sensing cushion according to claim 1, wherein the force sensor matrix is further configured to determine whether there is a user sitting on the force sensing cushion or not.
